(19) United States
(12) Patent Application Publication
(10) Pub. No.: US 2024/0077163 A1
(43) Pub. Date: Mar. 7, 2024

(54) LINED MAINLINE SERVICE SEALING AND REINFORCEMENT INSERT AND METHOD OF INSTALLATION THEREOF

(71) Applicant: FORACTION INC., Mont-Saint-Hilaire (CA)

(72) Inventor: Luc Desmarteau, Saint-Bernard-de-Michaudville (CA)

(21) Appl. No.: 18/460,000

(22) Filed: Sep. 1, 2023

(30) Foreign Application Priority Data
Sep. 1, 2022 (CA) 3171786

(51) Int. Cl. F16L 55/11

(52) U.S. Cl. CPC F16L 55/1141

(57) ABSTRACT

A service sealing and reinforcement insert adapted to rehabilitate or reinforce a conduit junction between a main conduit and a service, the service reinforcement insert comprising a tubular portion and a flange portion extending radially therefrom. The insert can be manually or robotically installed, and it accommodates imperfectly aligned services. Made from resilient materials such as thermoplastic polyurethane, the insert is affixed using epoxy or any other suitable adhesive for structural integrity and sealing. Its conical shape aids in installation, while ribs and an angled lip optimize epoxy distribution and structural attachment. Optionally, the flange can incorporate a gasket to enhance sealing. This invention provides a reliable solution for sealing, reinforcing, and rehabilitating conduit junctions, prolonging their functional life.

### CROSS-REFERENCE TO RELATED APPLICATIONS

The present patent application claims the benefits of priority of the Canadian Patent Application No. 3,171,786 entitled “Lined Mainline Service Sealing and Reinforcement Insert and Method of Installation Thereof”, filed at the Canadian Intellectual Property Office on Sep. 1, 2022, the content of which is incorporated herein by reference.

### FIELD OF THE INVENTION

The present invention generally relates to mainline reinforcement inserts and a method of installing said mainline reinforcement inserts in a service conduit.

### BACKGROUND OF THE INVENTION

Conduits for fluids, such as water or sewage conduits, or gas or chemical pipes, deteriorate over time. For example, many of the water mains throughout North America are made from unlined cast-iron pipes or PVC, the preferred materials for water distribution systems up to the mid-1970's and beyond. Over time, such pipes deteriorate often due to corrosion, thereby becoming pitted and forming tubercules. This corroded material, in combination with mineral deposits, is known as encrustation and tuberculation.

Such deterioration typically results in leakage of the fluids, such as water or sewage, into the surrounding environment. For example, in 2013, the city of Toronto, Ontario experienced approximately 1700 water main breaks. These cause water pressure drops, and the leaking fluids can weaken the surrounding ground which can interfere with other underground systems, such as communication systems or other water or fluid bearing conduits. Such conduits need to be rehabilitated.

One approach to rehabilitation is to replace the deteriorated conduit. However, this can be a very costly and labour-intensive exercise when, for example, the conduit is a buried water pipe. In such instances, the replacement involves setting up a work area and digging up the pipe, known as “open-cut replacement”.

One solution is to deploy a cured-in-place structural liner within the conduit. For example, Canadian patent no. 2,361,960 of Mercier describes the use of a cured-in-place structural liner. The liner consists of two concentric tubular jackets (an outer and an inner jacket) made of a flexible material that are impregnated with an adhesive resin. Bonded to the inner surface of the inner jacket is a film that is impermeable to liquid to flow through the conduit. The liner is inserted into one end of a dry conduit and then pulled into place. A shaping step then occurs, where the liner is made to conform to the inner wall of the conduit. The liner is then cured in place by flowing heated water through the conduit. This causes the liner to become a rigid structure, bonded to the inner surface of the conduit.

A related issue but increasingly prominent issue is erosion, crumbling and failure of the conduit around a service attached to the conduit. The attachment between a conduit and service puts stress on the conduit immediately around the service. Similarly, after a structural liner is installed, the attachment between a conduit and service puts stress on the conduit immediately around the service. It is desirable for a seal to be formed around the conduit that will prevent or minimize leakage even if the conduit fails around the service after the installation of the structural liner. It is also desirable to have a method to seal the service in cases where the conduit around the service has already failed before the installation of the structural liner. In either case, once the liner is inserted, inflated and cured, the cured-in-place liner is supposed to last for decades in constant use without failure and minimizing leakage.

Approaches and devices to assist in sealing connections between conduits and services are known in the art, including in cases where there is a cured-in-place liner used. For example, United States Patent Publication no. 2010/0187813 discloses a connector with a tubular member and an annular flange that is used to connect a lateral pipe to a main pipe. The annular flange is glued to the inner surface of the main pipe and the tubular extends through an opening formed in the main pipe.

Similarly, Canadian Patent Application no. 3,033,915 discloses a service reinforcement sleeve with a flange and a tubular section that can be used, with epoxy, to bind a service to a structural liner such as a cured-in-pipe structural liner. Notably, the sleeve has flexible tabs with lips on the end of the tubular section opposite the flange to accommodate encrustation in the service.

Despite these advancements, there remains a need for a tighter and more secure method for rehabilitating services.

### SUMMARY OF THE INVENTION

The shortcomings of the prior art are generally mitigated by a method of installing a service sealing and reinforcement insert as described herein.

Within the present disclosure and associated drawings, any measurements, angles and/or designs are presented as exemplary embodiments. Understandably, any of such measurements, angles and/or designs may be adapted or varied in accordance with the present disclosure.

In one aspect of the invention, a lateral insert for a mainline conduit is provided. The insert comprises a tubular portion having a longitudinal length adapted to be inserted into a service aperture of the mainline conduit, the tubular portion comprising first and second open ends and an inner fluid channel between the first and second open ends. The insert further comprises a flange radially extending from the tubular portion, the flange being adapted to rest against a liner of the mainline conduit.

The tubular portion may have an outer diameter decreasing along the longitudinal length away from the flange portion. The tubular portion may have a conical shape. The conical shape of the tubular portion may form an angle α between an outer surface of the tubular portion and a base of the flange. The angle α may be greater than 90°.

The tubular portion may further comprise ribs extending along a portion of the longitudinal length of the tubular portion. The ribs may comprise a tapered portion away of the flange. The tapered portion may be at an angle β with the base of the flange. The angle β may be comprised between 96° and 97°.

The first end of the tubular portion may comprise a beveled edge forming an angled reinforcement ring. The angled reinforcement ring may have a thickness allowing flexing of the insert to adapt to the shape of the service aperture.

The flange may comprise a substantially flat portion extending radially from the tubular portion and an angled lip portion extending from the substantially flat portion. The lip portion may extend from the substantially flat portion at an angle of about 45°.

The insert may be made of resilient and flexible material. The material may be thermoplastic polyurethane. The tubular portion and the flange may form a single piece or be unitary.

In another aspect of the invention, a method of installing a service sealing and reinforcement insert is provided. The method comprises installing a structural liner on an inner surface of a conduit, perforating the liner and the conduit to create an aperture therefore exposing a service aperture, inserting a tubular portion of the insert into the service aperture for a flange of the insert extends radially from the tubular portion to rest against the liner and affixing the insert to the service conduit;

The method further may further comprise installing an annular body around the tubular portion of the insert to increase sealing against the structural liner.

The method further may further comprise affixing the insert within the service conduit by applying an adhesive about the tubular portion of the insert.

The method further may further comprise robotically installing the insert into the service aperture.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a top perspective view of a service sealing and reinforcement insert in accordance with the principles of the present invention.

FIG. 2 is a bottom perspective view of the service sealing and reinforcement insert of FIG. 1.

FIG. 3 is a front elevation view of the service sealing and reinforcement insert of FIG. 1.

FIG. 4 is a front elevation cross-sectional view of the service sealing and reinforcement insert of FIG. 1.

FIG. 5 is a top plan view of the service sealing and reinforcement insert of FIG. 1.

FIG. 6 is a side perspective view of the service sealing and reinforcement insert of FIG. 1 being installed in a conduit junction.

FIG. 7 is a side cross-sectional view of the service sealing and reinforcement insert of FIG. 1 installed in a conduit junction.

FIG. 8 is a side cross-sectional view of the service sealing and reinforcement insert of FIG. 1 installed in a conduit junction.

FIG. 9 is a front elevation view of a service sealing and reinforcement insert configured to be inserted into a 1-inch service in accordance with the principles of the present invention.

FIG. 10 is a front elevation cross-sectional view of the service sealing and reinforcement insert of FIG. 9.

FIG. 11 is a top plan view of the service sealing and reinforcement insert of FIG. 9.

FIG. 12 is a front elevation view of a service sealing and reinforcement insert configured to be inserted into a 1.5-inch service in accordance with the principles of the present invention.

FIG. 13 is a front elevation cross-sectional view of the service sealing and reinforcement insert of FIG. 12.

FIG. 14 is a top plan view of the service sealing and reinforcement insert of FIG. 12.

FIG. 15 is a front elevation view of a service sealing and reinforcement insert configured to be inserted into a 2-inch service in accordance with the principles of the present invention.

FIG. 16 is a front elevation cross-sectional view of the service sealing and reinforcement insert of FIG. 15.

FIG. 17 is a top plan view of the service sealing and reinforcement insert of FIG. 15.

### DETAILED DESCRIPTION OF THE INVENTION

A novel service sealing and reinforcement insert and method of installation thereof will be described hereinafter. Although the invention is described in terms of specific illustrative embodiments, it is to be understood that the embodiments described herein are by way of example only and that the scope of the invention is not intended to be limited thereby.

Although the invention is described in terms of specific measurements of the service sealing and reinforcement insert and its components, it is to be understood that said measurements described herein are by way of example only and that the scope of the invention is not intended to be limited thereby.

As described in greater detail below, the present invention is directed to a service sealing and reinforcement insert 100 adapted to seal and rehabilitate or reinforce a conduit junction 30 between a main conduit 10 and a service 20.

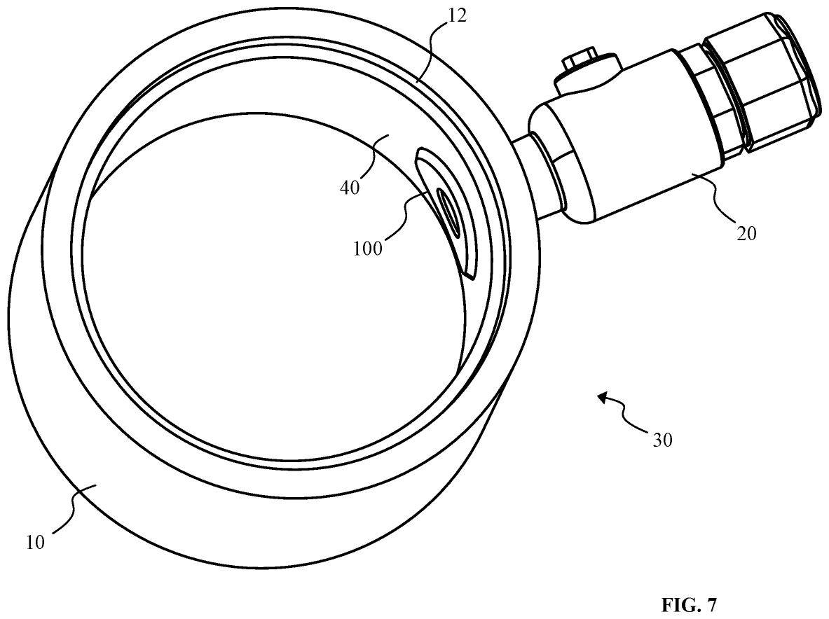

Referring to FIGS. 6 to 8, an exemplary conduit junction 30 between a main conduit 10 and a service 20 is illustrated. Typically, a sealing and reinforcement or rehabilitation of the conduit 10 and service 20 is necessary when the conduit junction 30 between said conduit 10 and service 20 deteriorates resulting in a leakage of fluid into surrounding area 5. A rehabilitation of the conduit 10 and service 20 may be achieved by installing a liner 40 to create a structural barrier having sufficient structural and functional integrity to function as a replacement conduit even if the conduit 10 fails. The structural liner 40 is typically apposed against the inner wall 12 of the conduit 10 using any means including, but not limited to, by manual installation, robotic installation or any other suitable means. A hole or perforation 42 is thereafter drilled or cut into the liner to expose a service aperture 22 of the service 20. The service aperture 22 provides fluid communication between the conduit 10 and the service 20 across the structural liner 40.

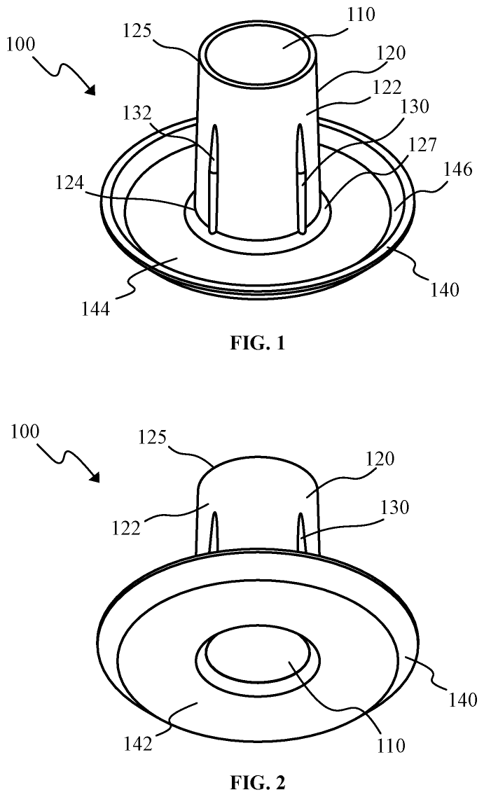

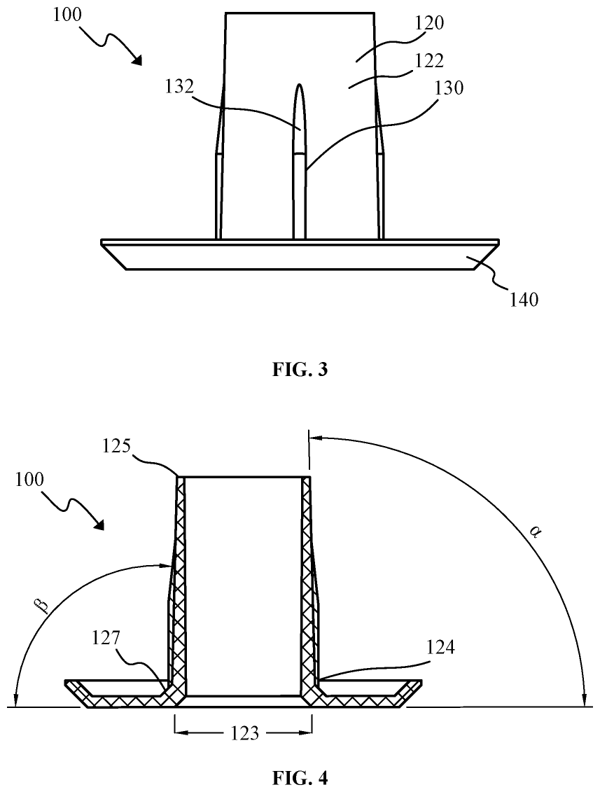

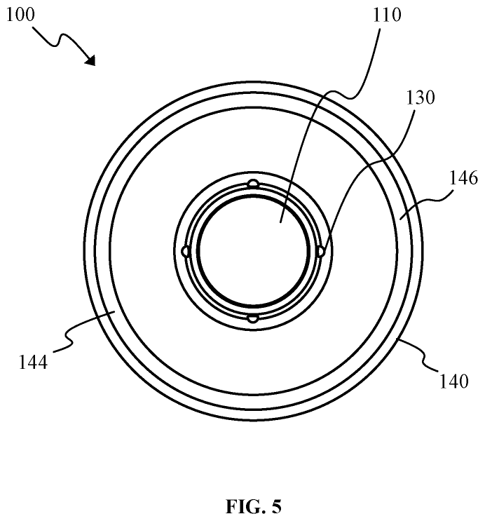

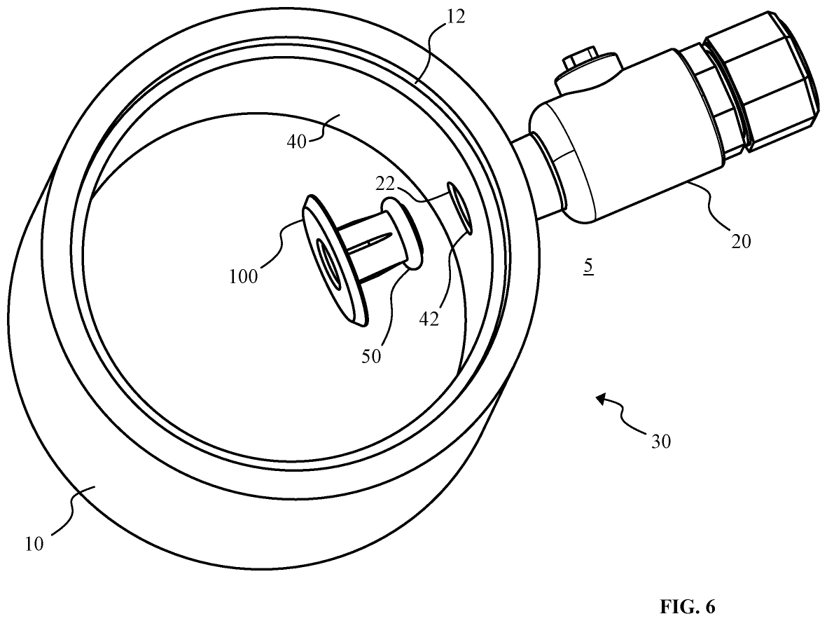

Referring now to FIGS. 1 to 5, an embodiment of a service sealing and reinforcement insert 100 is illustrated. Broadly, the insert 100 is configured to secure the structural liner 40 to the service conduit junction 30. Broadly, the insert 100 comprises a tubular portion 120 adapted to be inserted into the service aperture 22, and a flange 140 extending radially from the tubular portion 120 and adapted to rest against the liner 40 of the conduit 10 to ensure an adequate seal between the liner 40 and the service 20. In certain embodiments, the insert 100 may be unitary with the tubular 120 and the flange 140 forming a single piece. Alternatively, the tubular portion 120 and the flange 140 may be two distinct pieces attached or affixed to each other using any suitable means.

The insert 100 may be installed by any means including, but not limited to, by manual installation, robotic installation or any other suitable means. When installed by robotic installation, the insert 100 may be installed by a robotic system equipped with a specialized tool for manipulating the insert 100 and inserting said insert 100 from within the conduit 10 and into the service 20.

The insert 100 may be made of any suitable resilient material such as, for example, any plastic capable of flexing to accommodate any possible imperfections in the structural liner 40 or the service 20. In certain embodiments, the insert 100 may be made of thermoplastic polyurethane (hereinafter “TPU”). In a preferred embodiment, the insert 100 may be made of Grade 90D TPU meeting the NSF 61 certification. The insert 100 is preferably made of a material suitable for allowing the tubular portion 120 to curve sufficiently to accommodate insertion into a service 20 not being installed perfectly orthogonal to the conduit 10. The insert 100 may have any suitable longitudinal length and in a preferred embodiment has a length of 31.02 mm.

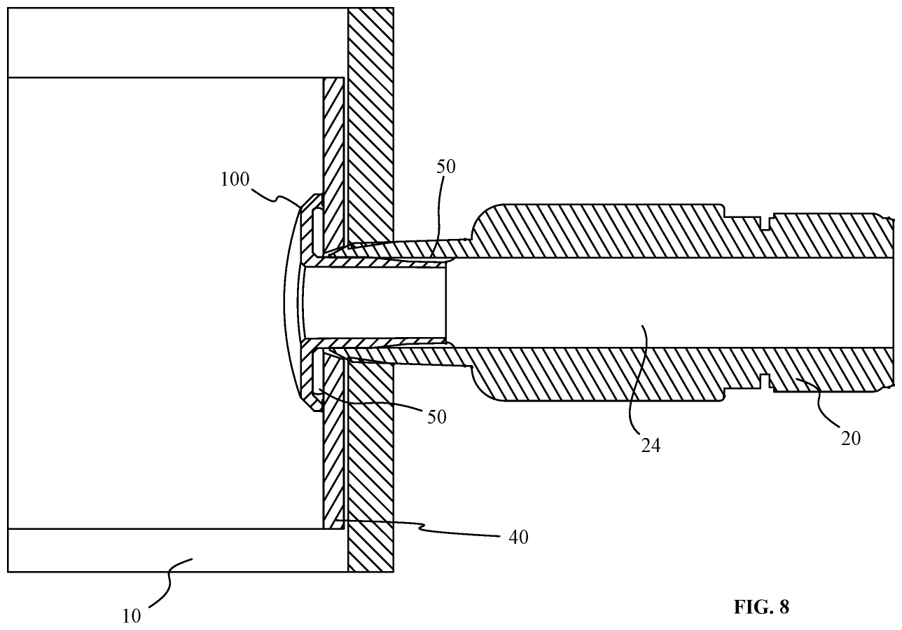

During installation, the insert 100 may be affixed within the service 20 using any suitable adhesive such as, for example, an epoxy resin. In a preferred embodiment, the insert 10 is installed using an NSF/ANSI 61 certified potable water epoxy 50 (shown in FIGS. 6 and 8). Said epoxy 50 may provide suitable adhesion of the liner 40 to the service 20, while providing appropriate sealing and structural strength.

Referring to FIG. 6, the insert 100 is illustrated prior to being inserted into the service aperture 22. In certain embodiments, the epoxy 50 is applied about the tubular portion 120. As described in greater detail below, the insert 100 is configured to distribute the epoxy 50 as the insert 100 is compressed during insertion thereof. Referring to FIG. 8, the insert 100 is illustrated inserted into the service 20 with the epoxy 50 distributed along the tubular portion 120 and the flange portion 140.

Still referring to FIGS. 1 to 4, the tubular portion 120 of the insert 100 comprises an aperture 110 forming a fluid channel through the insert 100. The tubular portion 120 may form a conical shape with a circumference of an outer surface 122 of said tubular portion 120 reducing along a longitudinal length away from the flange portion 140. The conical shape of the tubular portion 120 may therefore form an angle α between said outer surface 122 of the tubular portion 120 and a base 142 of the flange portion 140 being greater than 90°. In certain embodiments, the angle α may be between 91° and 92°. In a preferred embodiment, the angle α is 91.38°. The tubular portion 120 may have any suitable longitudinal length and in a preferred embodiment has a length of 29.3 mm.

In accordance with the conical shape of the tubular portion 120, an outer diameter 123 of said tubular portion 120 may similarly decrease along a longitudinal length away from the flange portion 140. In certain embodiments, the outer diameter ratio between a first end 124 of tubular portion 120 to a second end 125 of the tubular portion 120 may be between 1.07 and 1.08. In a preferred embodiment, the outer diameter ratio between the first end 124 and the second end 125 is 1.075. In such embodiments, the outer diameter 123 at the first end 124 may be 19.25 mm and the outer diameter 123 at the second end 125 may be 17.9 mm. The aforementioned outer diameter ratio may facilitate demolding of the insert 100 during manufacturing and installation thereof into the service 20. The aforementioned outer diameter ratio may further encourage or facilitate the adhesion of the epoxy 50 on the inner wall 24 of the service 20 by evenly distributing the pressure exerted on the epoxy 50 during the installation.

The tubular portion 120 may further comprise ribs 130 extending along the longitudinal length of the tubular portion 120. The ribs 130 may help guide or position the tubular portion 120 during installation in the service 20 while ensuring sufficient gap between the outer surface 122 of said tubular portion 120 and the inner wall 24 of the service 20 for the epoxy 50 to settle and dry. In certain embodiments, the ribs 130 may extend from the flange portion 140 along 20 to 21 mm up the tubular portion 120. In a preferred embodiment, the ribs 130 extend a length of 20.83 mm. The ribs 130 may have any suitable width such as, for example, a width of between 1 and 2 mm. In a preferred embodiment, the ribs 130 have a width of 1.5 mm.

The ribs 130 may further comprise an angled or tapered portion 132 forming an angle β with the base 142 of the flange portion 140. In certain embodiments, the angle β may be between 96° and 97°. In a preferred embodiment, the angle β is 96.31°. In certain embodiments, the tapered portion 132 may extend between 8 and 9 mm along the ribs 130. In a preferred embodiment, the tapered portion 132 extends a length of 8.54 mm. The ribs 130 may further comprise a curved cross-sectional shape.

The first end 124 of the tubular portion 120 may comprise a beveled edge forming an angled reinforcement ring 127 having an outer diameter suitable for maintaining sufficient pressure against the inner wall 24 of the service 20 to retain the insert 100 in place while the epoxy 50 solidifies while leaving sufficient space along the ribs for the presence of the epoxy 50. The outer diameter of the beveled edge 127 may be between 20.0 mm and 20.4 mm. In a preferred embodiment, the outer diameter of the beveled edge is 20.2 mm. The angled reinforcement ring may form a 45° with the base 142 of the flange portion 140. The angled reinforcement ring may further comprise a thickness suitable for allowing suitable flexibility of the insert 100 as it adapts to the shape of the service 20. In a preferred embodiment, the angled reinforcement ring 127 has a thickness of about 2.42 mm.

The flange portion 140 may comprise a substantially flat portion 144 extending radially from the tubular portion 120 and an angled lip portion 146 extending from the substantially flat portion 144 to contact the liner 40 during installation. As pressure is exerted onto the insert 100 during installation thereof, the flange portion 140 may collect excess epoxy 50 emanating from the service 20. When collected in the flange portion 140, the epoxy 50 may penetrate any cavities on the liner 40 or the inner wall 12 of the conduit 10. The epoxy 50 may further solidify forming an additional attachment point of the insert 100.

In certain embodiments, the lip portion 146 may extend from the substantially flat portion 144 at an angle of about 45° and may comprise a thickness of about 1.5 mm. To that end, the lip portion 146 may form a protective barrier to shield the epoxy 50 from degradation by deflecting the impact of the water flow against the insert 100 within the conduit 10. The lip portion 146 may further serve to prevent the epoxy 50 from extending beyond the insert 100 during installation thereof while retaining sufficient flexibility to adapt to inconsistencies in the liner 40.

In certain embodiments, the flange portion 140 may be adapted to receive a gasket (not shown) to be installed against the structural liner 40 while surrounding the service aperture 22. The gasket may therefore comprise an annular body configured to be installed about the tubular portion 120. In particular, the annular body may be installed to increase the seal against the liner and to minimize fluid flow across the conduit junction 30 thereby enhancing the rehabilitation of the service 20. The gasket may be made of any resilient and compressible material such as, but not limited to, rubber, foam or plastic.

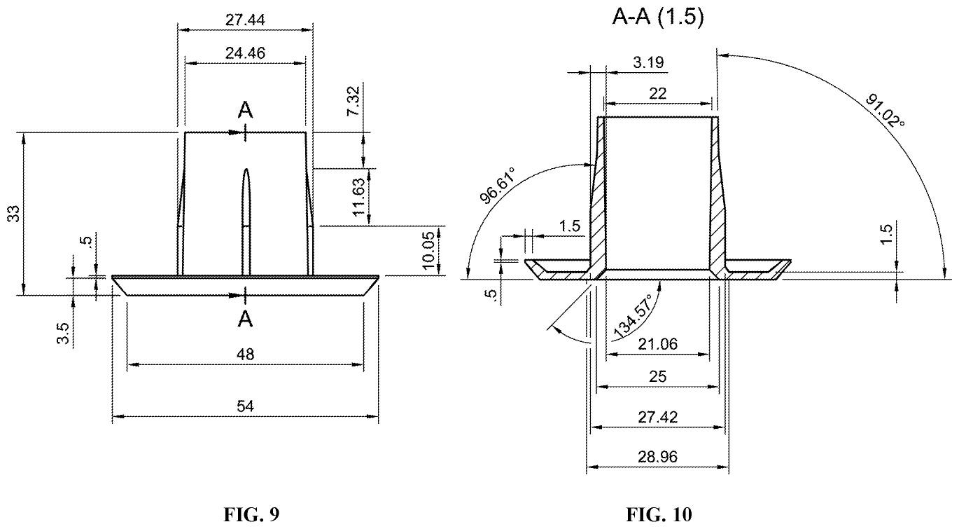

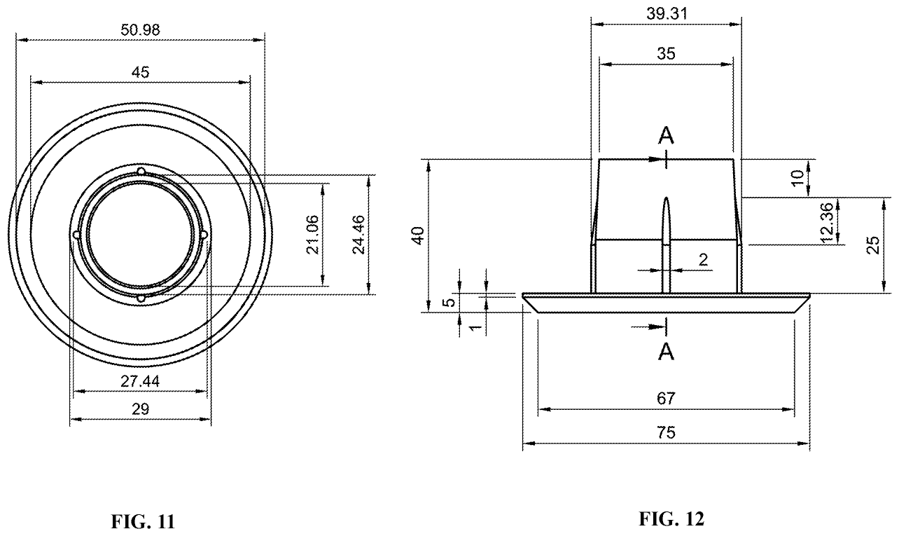

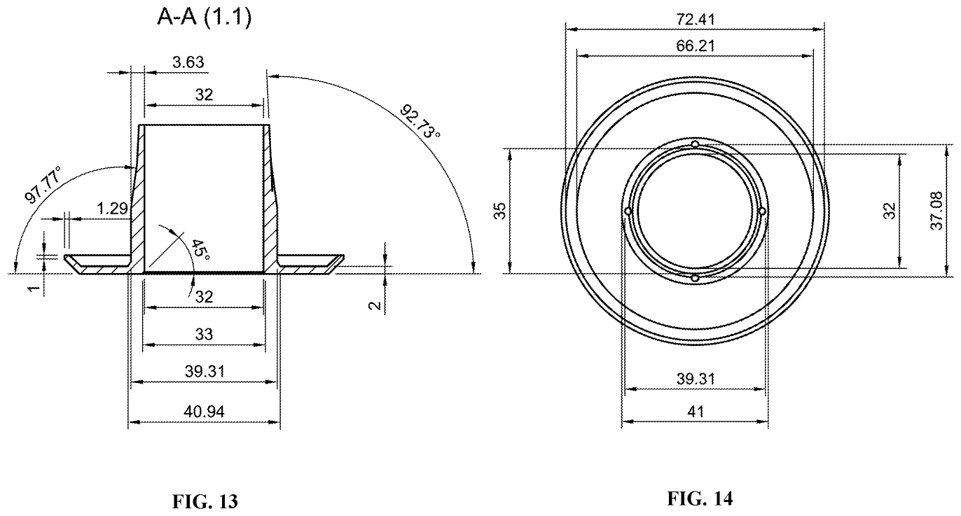

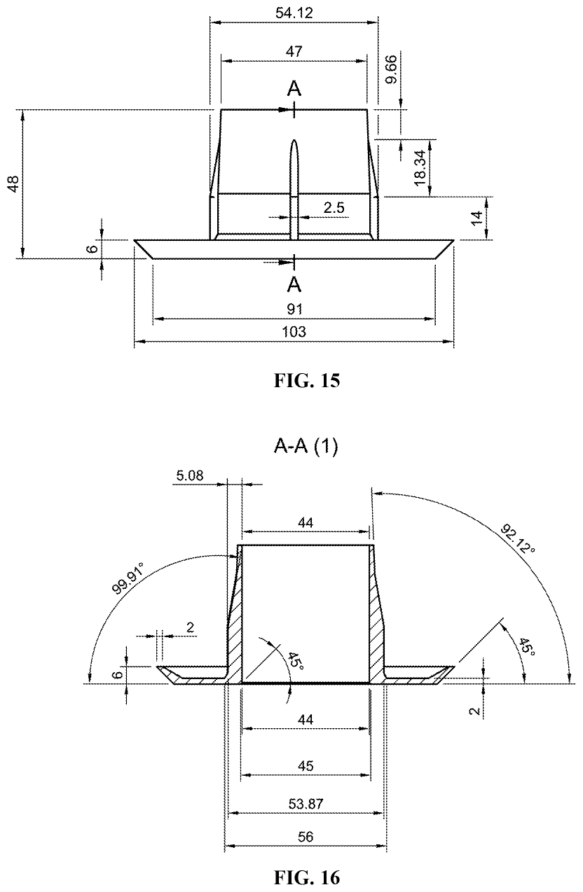

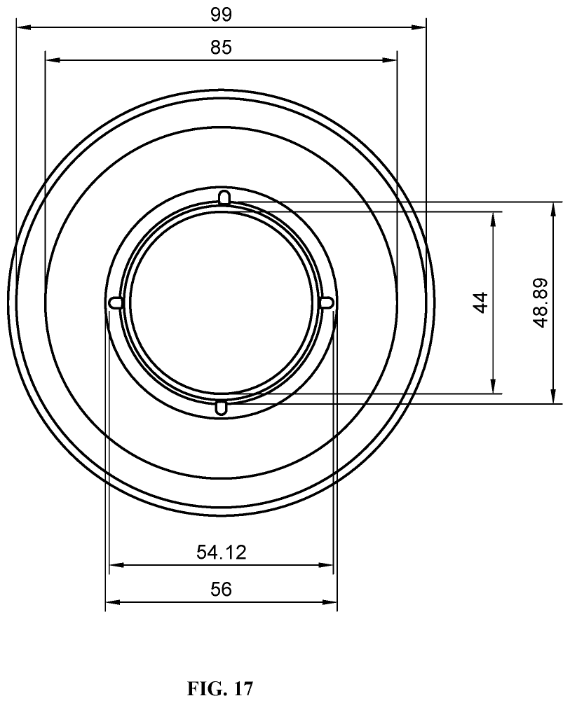

Referring now to FIGS. 9 to 17, various embodiments of service sealing and reinforcement inserts are illustrated. More specifically, FIGS. 9 to 11 illustrate a service reinforcement insert configured to be inserted in a 1-inch service, FIGS. 12 to 14 illustrate a service sealing and reinforcement insert configured to be inserted in a 1.5-inch service, and FIGS. 15 to 17 illustrate a service sealing and reinforcement insert configured to be inserted in a 2-inch service.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A lateral insert for a mainline conduit, the insert comprising:
a tubular portion having a longitudinal length adapted to be inserted into a service aperture of the mainline conduit, the tubular portion comprising
first and second open ends; and
an inner fluid channel between the first and second open ends; and
a flange radially extending from the tubular portion, the flange being adapted to rest against a liner of the mainline conduit.

2. The insert of claim 1, the tubular portion having an outer diameter decreasing along the longitudinal length away from the flange portion.

3. The insert of claim 2, the tubular portion having a conical shape.

4. The insert of claim 3, the conical shape of the tubular portion forming an angle α between an outer surface of the tubular portion and a base of the flange.

5. The insert of claim 4, the angle α being greater than 90°.

6. The insert of claim 1, the tubular portion further comprising ribs extending along a portion of the longitudinal length of the tubular portion.

7. The insert of claim 6, the ribs comprising a tapered portion away of the flange.

8. The insert of claim 7, the tapered portion being at an angle β with the base of the flange.

9. The insert of claim 8, the angle β being comprised between 96° and 97°.

10. The insert of claim 1, the first end of the tubular portion comprising a beveled edge forming an angled reinforcement ring.

11. The insert of claim 10, the angled reinforcement ring having a thickness allowing flexing of the insert to adapt to the shape of the service aperture.

12. The insert of claim 1, the flange comprising a substantially flat portion extending radially from the tubular portion and an angled lip portion extending from the substantially flat portion.

13. The insert of claim 12, the lip portion extending from the substantially flat portion at an angle of about 45°.

14. The insert of claim 1, the insert being made of resilient and flexible material.

15. The insert of claim 14, the material being thermoplastic polyurethane.

16. The insert of claim 1, the tubular portion and the flange forming a single piece.

17. A method of installing a service sealing and reinforcement insert, the method comprising:
installing a structural liner on an inner surface of a conduit;
perforating the liner and the conduit to create an aperture therefore exposing a service aperture;
inserting a tubular portion of the insert into the service aperture for a flange of the insert extends radially from the tubular portion to rest against the liner; and
affixing the insert to the service conduit.

18. The method of claim 17, the method further comprising installing an annular body around the tubular portion of the insert to increase sealing against the structural liner.

19. The method of claim 17 further comprising affixing the insert within the service conduit by applying an adhesive about the tubular portion of the insert.

20. The method of claim 17 further comprising robotically installing the insert into the service aperture.
